(19) United States
(12) Patent Application Publication
(10) Pub. No.: US 2013/0073797 A1
(43) Pub. Date: Mar. 21, 2013

(54) MEMORY DEVICE

(71) Applicant: Rafat CHOWDHURY, Moriya-shi (JP)

(72) Inventor: Rafat CHOWDHURY, Moriya-shi (JP)

(21) Appl. No.: 13/428,472

(22) Filed: Mar. 23, 2012

(30) Foreign Application Priority Data
Sep. 21, 2011 (JP) 2011-206384

(51) Int. Cl. G06F 12/02

(52) U.S. Cl. 711/103; 711/E12.008

(57) ABSTRACT

According to one embodiment, a memory device includes a nonvolatile memory and a command storage module in which a command is stored. The memory device further comprises a memory module in which a type of a background process and an order of priority of the background process are set, in which information of a necessary background process is set, and in which permission or refusal of the background process is set by a host device.

### CROSS-REFERENCE TO RELATED APPLICATIONS

This application is based upon and claims the benefit of priority from prior Japanese Patent Application No. 2011-206384, filed Sep. 21, 2011, the entire contents of which are incorporated herein by reference.

### FIELD

Embodiments described herein relate generally to a memory device.

### BACKGROUND

There are various mediums that hold data. One of them is, for example, a universal flash storage (UFS) memory device. A conventional memory device cannot clearly distinguish between an unnecessary background process and a necessary background process and therefore cannot perform a background process efficiently, resulting in a decrease in the performance of the memory device.

### BRIEF DESCRIPTION OF THE DRAWINGS

FIG. 1 shows a hardware configuration of a memory device according to a first embodiment;

FIG. 2 is a circuit diagram of a memory according to the first embodiment;

FIG. 3 shows a configuration of a memory space according to the first embodiment;

FIG. 4 shows a state where memory devices are sealed in the first embodiment;

FIG. 5 shows a functional block of a host device according to the first embodiment;

FIG. 6 shows a functional block of a memory device according to the first embodiment;

FIG. 7 shows a packet according to the first embodiment;

FIG. 8 shows a conversion table for logical addresses and physical addresses in the first embodiment;

FIG. 9 is a diagram showing the types of background processes and orders of priority in the first embodiment;

FIG. 10 is a flowchart to explain the operation of setting an order of importance and an order of necessity in a memory device according to the first embodiment;

FIG. 11 is a flowchart to explain the operation of performing a background process in a memory device according to the first embodiment; and

FIG. 12 is a flowchart to explain the operation when a power-related command is input to a memory device according to a second embodiment during a background process of the memory device.

### DETAILED DESCRIPTION

In general, according to one embodiment, a memory device comprises a nonvolatile memory and a command storage module in which a command is stored. The memory device further comprises a memory module in which a type of a background process and an order of priority of the background process are set, in which information of first (necessary) background processes are set, and in which permission or refusal of the background process is set by a host device. The memory device further comprises a management module which, having determined that no command has been stored in the command storage module, refers to the memory module and determines whether the host device has given permission for the background process to be performed and which, if the host device has not given permission for the background process to be performed, checks orders of priority and the number of background processes from the number of unused blocks in the memory and information of the necessary background processes set in the memory module and sets the order of importance of the background process in the memory module based on the number of unused blocks in the memory and the orders of priority of the necessary background processes, and the number of necessary background processes.

Hereinafter, referring to the accompanying drawings, embodiments will be explained. In an explanation below, structural elements that have almost the same functions and configurations are indicated by the same reference numbers. Each embodiment described below illustrates an apparatus or a method for embodying the technical idea of the embodiment. The technical idea of the embodiment does not limit the materials, shapes, structures, arrangements, and others of component parts to those described below. The technical idea of the embodiment may be modified variously within the scope of the accompanying claims.

### First Embodiment

### 1.1 Configuration

### 1.1.1 Overview of Memory Device

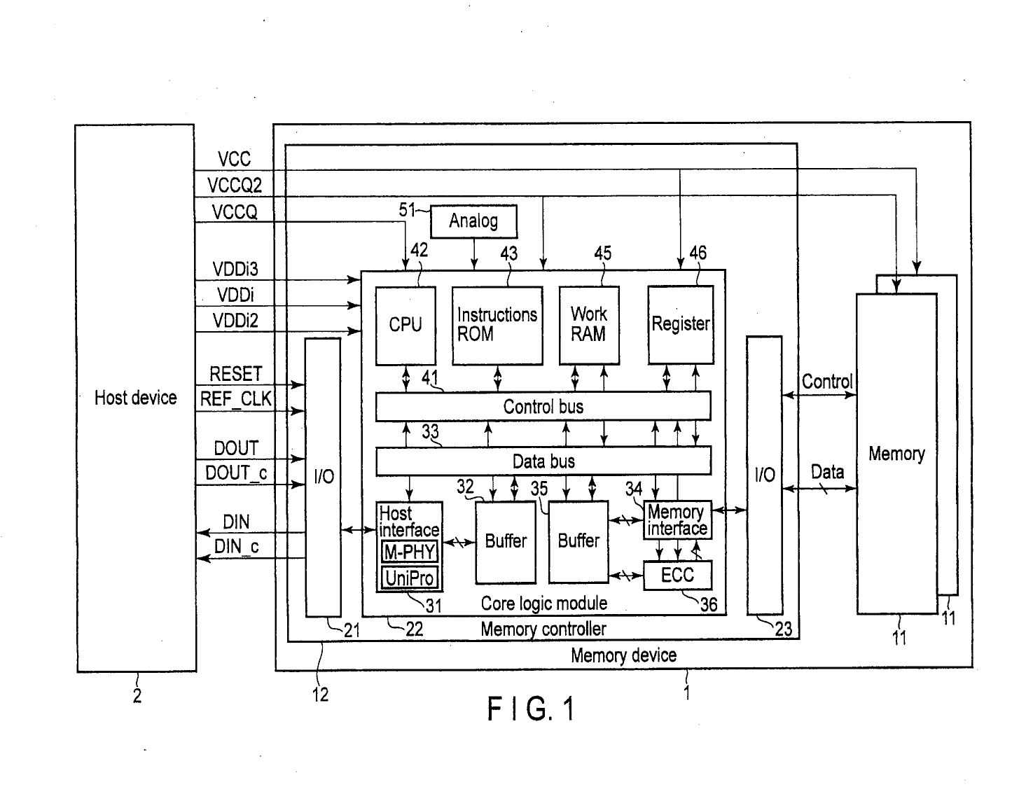

FIG. 1 schematically shows a memory device according to a first embodiment. FIG. 1 shows a hardware configuration of the memory device.

As shown in FIG. 1, the memory device (semiconductor memory device) 1 is configured to be capable of communicating with a host device (hereinafter, sometimes just referred to as a host) 2. The memory device 1 functions as a target and the host device 2 functions as an initiator. Specifically, for example, the memory device 1 is a UFS memory device and the host device 2 is a host that supports the UFS memory device.

The memory device 1 comprises at least a nonvolatile semiconductor memory 11 and a memory controller 12 for controlling the memory 11. The memory 11 writes and reads data in specific write units of a plurality of bits. In addition, the memory 11 erases data in erase units of a plurality of write units.

The memory device 1 further comprises an I/O 21, a core logic module 22, and an I/O 23. The I/O 21 includes a hardware configuration that connects the memory device 1 with the host device 2. If the memory device 1 is a UFS memory device, the signals exchanged between the memory device 1 and host device 2 include RESET, REF_CLK, DOUT, DOUT_c, DIN, DIN_c, VCC, VCCQ, VCCQ2, VDDi, VDDi2, and VDDi3. RESET, REF_CLK, DOUT, DOUT_c, DIN, and DIN_c are exchanged between the host device 2 and I/O 21. RESET is a hardware reset signal. REF_CLK is a reference clock. DOUT and DOUT_c form a differential signal pair and are transmitted from the host device 2 to the memory device 1. DIN and DIN_c form a differential signal pair and are transmitted from the memory device 1 to the host device 2. VCC, VCCQ, and VCCQ2 are power supply voltages supplied to the memory 11 and core logic module 22. VDDi, VDDi2, and VDDi3 are supplied to the core logic module 22. They are input when a voltage regulator is provided in the core logic module 22.

The core logic module 22 is the main part of the memory controller 12 excluding the I/Os. The I/O 23 includes a hardware configuration for connecting the memory controller 12 with the memory 11. The core logic module 22 comprises a host interface 31, a buffer 32, a data bus 33, a memory interface 34, a buffer 35, an ECC circuit 36, a control bus 41, a central processing unit (CPU) 42, a read-only memory (ROM) 43, a random-access memory (work RAM) 45, and a register 46.

The I/O 21 is connected with the host interface 31. The host interface 31 performs a process necessary for communication between the memory device 1 and host device 2. Specifically, the host interface 31 supervises communication between the memory device 1 and host device 2 according to a communication protocol to which both the memory device 1 and host device 2 conform. If the memory device 1 is a UFS memory device, for example, the host interface 31 is a USF interface. The UFS interface complies with the M-PHY standard in terms of a physical layer and with the UniPro standard in terms of a link layer.

The host interface 31 is connected to the buffer 32. The buffer 32 receives data transmitted from the host device 2 via the host interface 31 to the memory device 1 and holds the data temporarily. The buffer 32 further temporarily holds data transmitted from the memory device 1 to the host device 2 via the host interface 31. The buffer 32 is connected to the data bus 33.

The I/O 23 is connected to the memory interface 34. The memory interface 34 performs a process necessary for communication between the memory controller 12 and the memory 11. Specifically, the memory interface 34 transmits an instruction from the core logic module 22 in the form the memory 11 can recognize. If the memory 11 is a NAND flash memory, the memory interface 34 is a NAND flash interface. The memory 11 is not limited to a NAND flash memory and may be any type of memory, provided that it is a nonvolatile memory.

The memory interface 34 is connected to the buffer 35. The buffer 35 receives data transmitted from the memory 11 to the memory controller 12 via the memory interface 34 and holds the data temporarily. The buffer 35 further temporarily holds data to be transmitted from the memory controller 12 to the memory 11 via the memory interface 34. The buffer 35 is connected to the data bus 33. The memory interface 34 and buffer 35 are connected to the error correcting code (ECC) circuit 36. The ECC circuit 36 is also connected to the data buffer 35. The ECC circuit 36 receives write data from the host device 2 via the data bus 33, adds error correction code to the write data, and supplies the error-correcting-code-added write data to the buffer 35. The ECC circuit 36 further receives data supplied from the memory 11 via the buffer 35, corrects errors in the data using the error correcting code, and supplies the error-corrected data to the data bus 33.

Connected to the control bus 41 are the CPU 42, ROM 43, RAM 45, and register 46. The CPU 42, ROM 43, RAM 45, and register 46 communicate with one another via the control bus 41. The CPU 42 supervises the overall operation of the memory device 1. The CPU 42 executes a specific process according to a control program (instructions) stored in the ROM 43. The CPU 42 performs a specific process on the memory 11 according to a command received from the host device 2 according to the control program.

The ROM 43 stores a control program or the like controlled by the CPU 42. The RAM 45 is used as a work area of the CPU 42 and temporarily stores variables and the like necessary for the work of the CPU 42. The register 46 holds various values necessary for the operation of the memory device 1. The register 46 further holds various values necessary for the host device 2 to control the memory device 1.

Connected to the control bus 41 are the host interface 31, buffer 32, memory interface 34, and buffer 35. On the basis of the control program or an instruction from the host device 2, the CPU 42 controls the host interface 31, buffer 32, memory interface 34, and buffer 35. The memory controller 12 may be provided with an analog circuit 51.

### 1.1.2 Overview of Memory

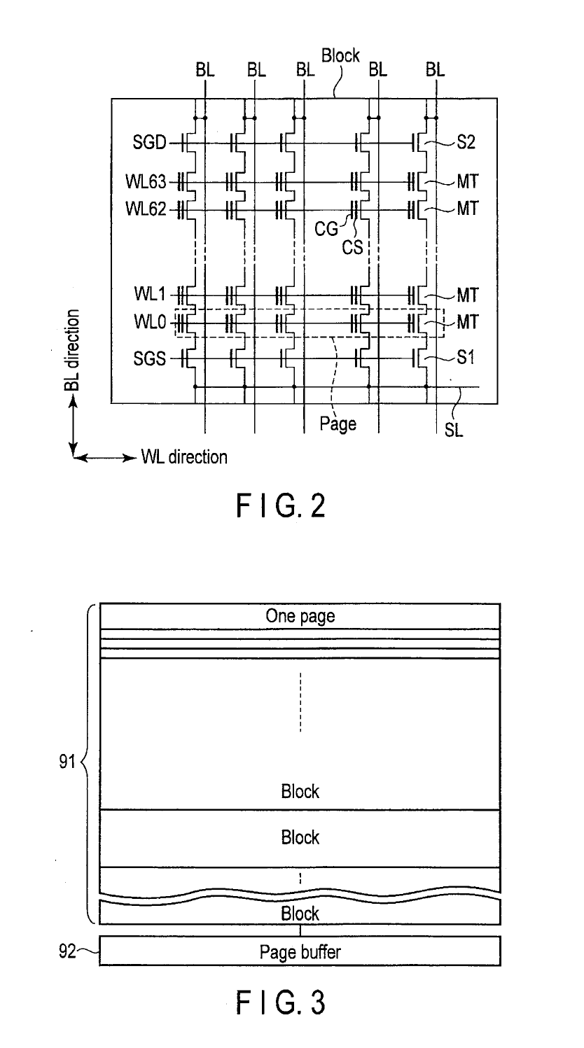

For example, the memory 11 includes one or a plurality of NAND flash memories. If the memory 11 is a NAND flash memory, the memory 11 writes and reads data in pages. As shown in FIG. 2, a page is composed of a memory space of a set of a plurality of memory cell transistors. A unique physical address is allocated to a page. Each of the memory cell transistors (also referred to as memory cells or cell transistors) MT is a metal oxide semiconductor field-effect transistor (MOSFET) with a so-called stacked gate structure. In each memory cell transistor MT, its threshold voltage varies according to the number of electrons stored in a charge storage layer CS. The memory cell transistor MT memorizes information according to the difference in the threshold voltage. The current paths (source/drain SD) of memory cell transistors MT are connected in series, thereby forming a NAND string. Select transistor S1 is connected to one end of the NAND string and select transistor S2 is connected to the other end of the NAND string. The other end of the current path of select transistor S2 is connected to a bit line BL and the other end of the current path of select transistor S1 is connected to a source line SL.

Word lines WL0 to WL63 extend in a WL direction and are connected to the control gates CG of the memory cell transistors MT belonging to the same row. The memory cell transistors MT are provided at the intersections of bit lines BL and word lines WL in a one-to-one correspondence. A select gate line SGD extends in the WL direction and is connected to all the select transistors S2 in a block. A select gate line SGS extends in the WL direction and is connected to all the select transistors S1 in a block. A plurality of memory cell transistors connected to the same word line WL constitute a page.

As shown in FIG. 3, the memory 11 comprises a memory cell array 91 that includes a plurality of memory cell transistors and a page buffer 92 that inputs data from and outputs data to the memory cell transistors. The page buffer 92 holds one page of data. When writing data to the memory 11, the memory controller 12 transmits a write commend together with a page address that indicates a write destination and one page of write data to the memory 11. The memory 11 stores the write data received from the memory controller 12 in the page buffer 92 and writes the write data in the page buffer 92 to the memory cells specified by the page address. Having started to write data to the memory cells, the memory 11 outputs a busy signal indicating “in operation” to the memory controller 12. On continuing to write data, the memory 11 performs the same operation at the next page address after the busy signal has been switched to a ready signal.

When reading data from the memory 11, the memory controller 12 transmits a read command together with a page address indicating a read destination to the memory 11. The memory 11 reads one page of data from the memory cells specified by the page address into the page buffer 92. Having started to read data from the memory cells, the memory 11 outputs a busy signal to the memory controller 12. Then, after the busy signal has been switched to a ready signal, the memory 11 outputs the data read into the page buffer 92 to the memory controller 12. On continuing to read data, the memory 11 performs the same operation at the next page address.

If the memory 11 is a NAND flash memory, a memory cell transistor MT may take two or more states differing in threshold voltage. That is, the memory 11 may be so configured that one memory cell can store multiple levels (multiple bits). In the case of a memory capable of storing multiple levels, a plurality of pages are allocated to one word line.

In addition, if the memory 11 is a NAND flash memory, the memory 11 erases data in blocks. Each block is composed of a plurality of pages that have consecutive physical addresses. In the explanation below, let a write unit be a page and an erase unit be a block for the sake of convenience. However, the memory 11 is not necessarily limited to a NAND flash memory.

### 1.1.3 Package of Memory

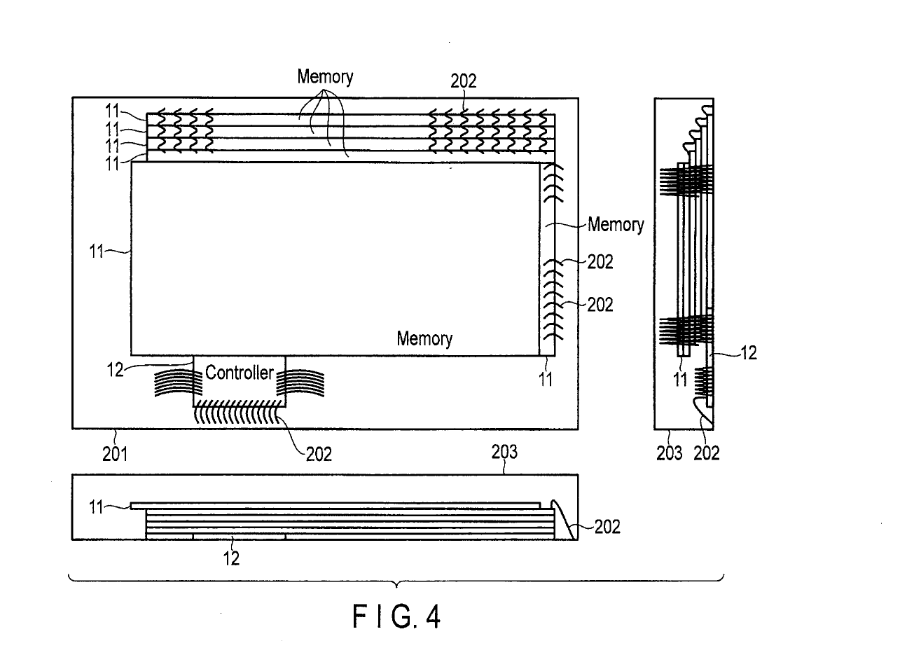

The memory device 11 may be, for example, of the embedded type where the memory device is solder-mounted on a printed circuit board or of the removable type where the memory device can be inserted in and removed from a card slot made in the host device 2. FIG. 4 shows an example of the memory device 1 in a sealed state. As shown in FIG. 4, a plurality of chip-like memories 11 are stacked one on top of another on a printed circuit board 201. Each memory 11 is connected to an interconnection pattern (not shown) on the printed circuit board 201 with wires 202. A chip-like memory controller 12 is also placed on the printed circuit board 201 and connected to the interconnection pattern with wires 202. On the underside of the printed circuit board 201, external terminals (not shown) (e.g., a ball grid array (BGA)) are provided. Allocated to the external terminals are RESET, REF_CLK, DOUT, DOUT_c, DIN, DIN_c, VCC, VCCQ, VCCQ2, VDDi, VDDi2, and VDDi3 shown in FIG. 1. The memory device 1 exchanges signals with the host device 2 outside the memory device 1 via the external terminals. The printed circuit board 201, memories 11, memory controller 12, and wires 202 are sealed with, for example, a resinous package 203.

### 1.1.4 Functional Configuration of Host Device

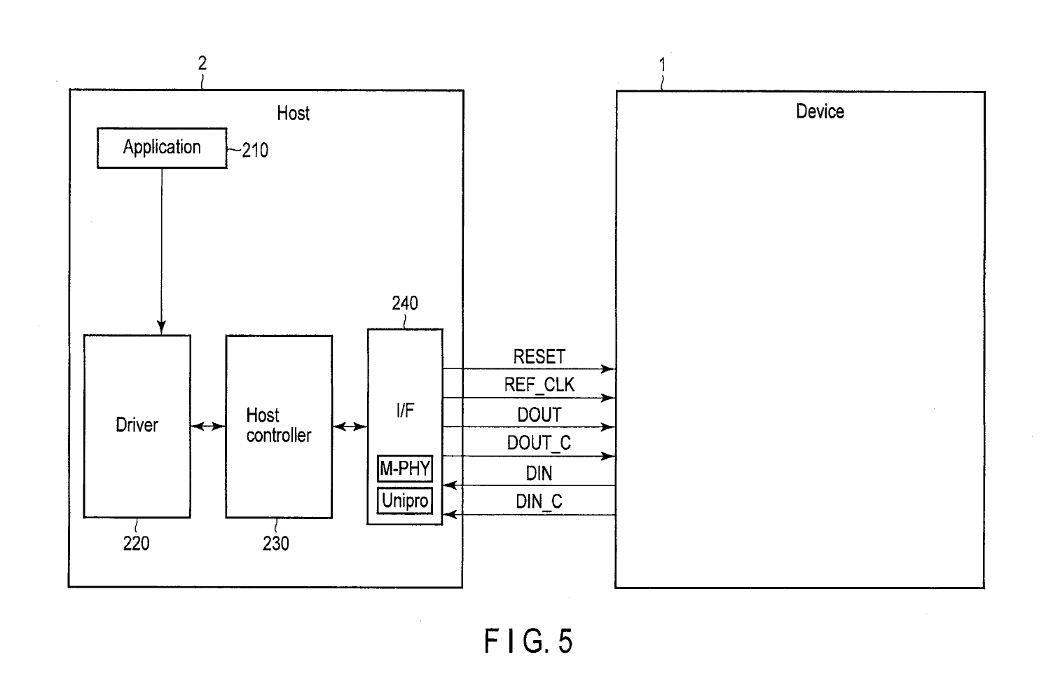

Next, FIG. 5 shows a configuration of the host device 2 from another viewpoint. Specifically, FIG. 5 shows a logical configuration of the host device 2, that is, a functional block of the host device 2. Each block can be realized by either hardware or computer software or by a combination of them. Whether each functional block is implemented in hardware or software depends on design constraints imposed on a specific embodiment or the entire system. Those skilled in the art can realize those functions by various methods for each specific embodiment. Any method of realizing the functions falls within the scope of the embodiment. Distinguishing the functional blocks as shown in concrete examples described below is not indispensable. For example, a part of the functions may be implemented by a functional block differing from the ones illustrated in the explanation below. In addition, the illustrated blocks may be further divided into functional sub-blocks. An embodiment is not limited, depending on which blocks constitute the embodiment.

The host device 2 comprises a driver 220, a host controller 230, and an interface 240. The host device 2 further comprises an application 210 that is to communicate with, for example, the memory device 1.

The application 210 communicates with the memory device 1 by use of the driver 220. The driver 220 manages the host controller 230 via a UFS host controller interface (UFSHCI) (not shown). For example, the memory device 1 and host controller 230 are connected to each other via the interface 240. The interface 240 has the same configuration as that of the host interface 31 described above.

### 1.1.5 Functional Configuration of Memory Device

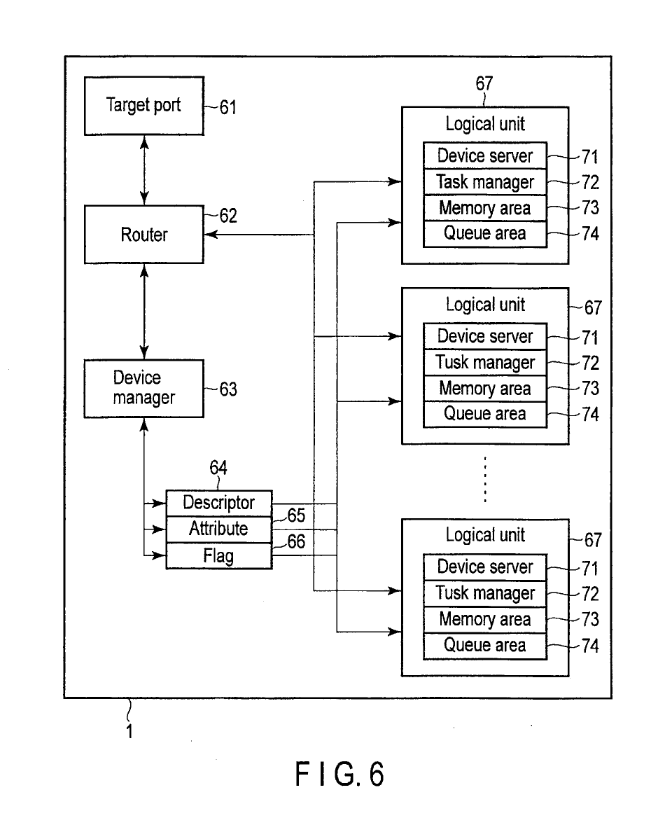

Next, FIG. 6 shows a configuration of the memory device 1 from another viewpoint. Specifically, FIG. 6 shows a logical configuration of the memory device 1, that is, a functional block of the memory device 1. Each block can be realized by either hardware or computer software or by a combination of them. Whether each functional block is implemented in hardware or software depends on design constraints imposed on a specific embodiment or the entire system. Those skilled in the art can realize those functions by various methods for each specific embodiment. Any method of realizing the functions falls within the scope of the embodiment. Distinguishing the functional blocks as shown in concrete examples described below is not indispensable. For example, a part of the functions may be implemented by a functional block differing from the ones illustrated in the explanation below. In addition, the illustrated blocks may be further divided into functional sub-blocks. An embodiment is not limited, depending on which blocks constitute the embodiment.

The memory device 1 comprises a target port 61, a router 62, a device manager 63, a descriptor 64, an attribute 65, a flag 66, and a plurality of logical units (LUs) 67. The target port 61 is for connecting the memory device 1 with the host device 2 to enable communication between them. The target port 61 corresponds to, for example, the host interface 31. The router 62 routes communication (task, command, data, query, and the like) received from the host device 2 to the logical unit 67 at the destination. The host device 2 requests the processing of a command or a task management function through a request addressed to one logical unit 67. The logical units 67 are identified by their addresses (e.g., logical unit numbers (LUNs)). Hereinafter, suppose commands include LU commands (write commands, read commands, or the like), tasks, and queries.

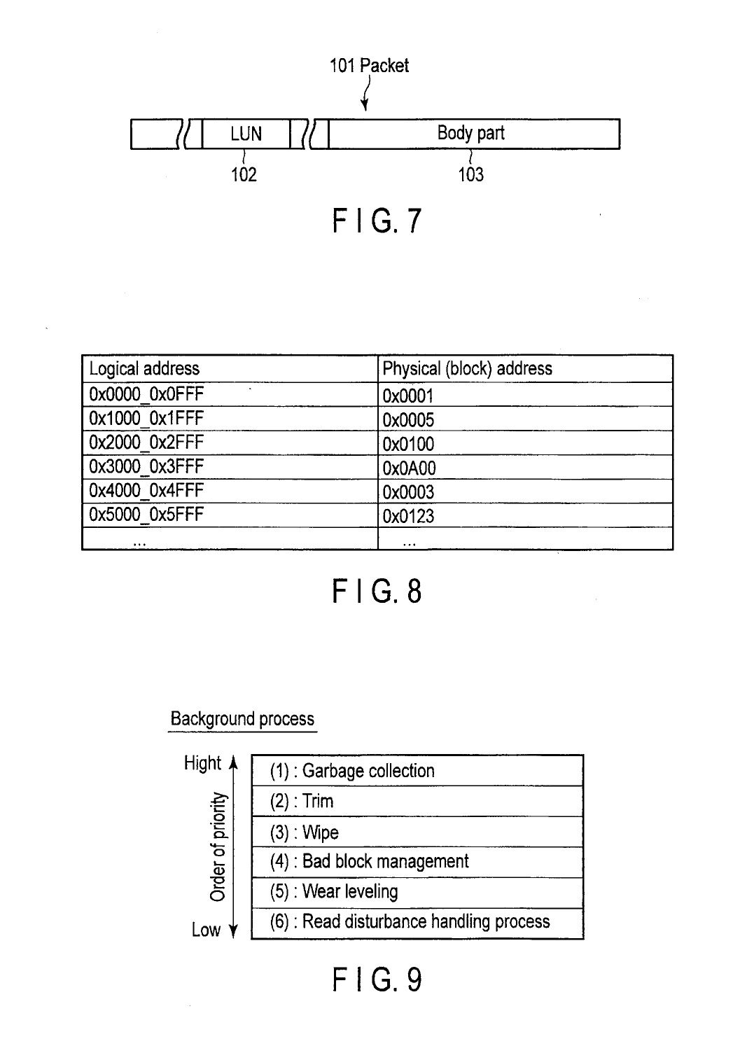

For example, as shown in FIG. 7, LUN can be included in (packet) communication between the memory device 1 and host device 2 in the UFS memory device.

A packet 101 includes a LUN 102 and a body part 103.

The LUN 102 can be included in, for example, the header of a packet 101. A logical unit 67 at the destination of each packet is determined uniquely by a LUN.

The body part 103 includes contents unique to the packet, for example, a task, data, an LU command, a query, various parameters, and the like. Specifically, the body part 103 of the packet includes a command description part. In the command description part, a small computer system interface (SCSI) command is stored. The SCSI command includes a specific command, an address, and others.

As shown in FIG. 6, the router 62 routes communication (including the task, LU command, data, and query) received from the host device 2 to the logical unit 67 at the destination on the basis of the LUN during communication. In addition, the router 62 transmits communication from a plurality of logical units 67 to the host device 2 in a time-division manner in a suitable sequence to the target port 61. The router 62 is realized by, for example, the CPU 42, ROM 43, and register 46. That is, the router 42 is realized by the CPU 42 executing a program in the ROM 43 referring to values in the register 46.

The device manager 63 manages device-level operations and configurations. The management of device levels includes, for example, the power management of the memory device 1 and control including sleep. The device-level configuration includes holding a group of descriptors. The device manager 63 processes such a command as a query request, a change and output request from the host device 2 for the change and output of configuration information of the memory device 1. The device manager 63 is realized by, for example, the CPU 42, ROM 43, and register 46. That is, the device manager 63 is realized by the CPU 42 executing a program in the ROM 43 referring to values in the register 46.

The descriptor 64, attribute 65, and flag 66 are realized in the form of data in, for example, the work RAM 45 and register 46.

The descriptor 64 has a data structure in a previously defined format and is for describing some characteristics of the memory device 1. The descriptor 64 includes, for example, a device class, a sub-class, a protocol, and the like necessary to access the memory device 1.

The attribute 65 is changeable or read-only parameters set for the memory device 1. The attribute 65 includes, for example, the maximum value of data transferable between the memory device 1 and host device 2.

The flag 66 is composed of an alternative logical value for each of various items and represented as, for example, “true” or “false” or as “0” or “1.”

### 1.1.6 Configuration of Logical Unit

Each logical unit 67 is realized by, for example, the memory 11, memory interface 34, buffer 35, ECC circuit 36, CPU 42, ROM 43, and register 46 (FIG. 1). The logical units 67 perform processes from the host device 2 independently of one another. Therefore, each logical unit 67 is realized by using a part of the resources that include the memory 11, memory interface 34, buffer 35, ECC circuit 36, CPU 42, ROM 43, and register 46. The individual LUs are distinguished from one another by the host device 2 using a LUN that determines one LU. A command from the host device 2 is executed by a specified logical unit 67.

Each of the logical units 67 comprises a device server 71, a task manager 72, a memory area 73, and a queue area 74.

The queue area 74, which is realized by such hardware as the work RAM 45 or register 46, holds tasks, LU commands, queries, and the like from the host device 2. The queue area 74 includes a command queue that holds an LU command (not shown), a task queue that holds a task, and a query queue that holds a query. Each of the command queue, task queue, and query queue (sometimes just referred to as a queue or a queue space) is one of the data structures that temporarily holds data repeatedly input and output.

The memory area 73 is composed of a part of the memory area of the memory 11 and stores write data from, for example, the host device 2.

The device manager 71 and task manager 73 are realized by, for example, the CPU 42, ROM 43, and register 46. That is, the device manager 71 and task manger 73 are realized by the CPU 42 executing a program in the ROM 43 referring to values in the register 46.

The device server 71 interprets a command requesting an LU-level process received from the host device 2. Specifically, the device server 71 determines whether the command is a task, an LU command, or a query and allocates them to specific areas in the queue area 74. In addition, the device server 71 executes a task, an LU command, or a query. Such a process includes, for example, writing data, reading data, and erasing data.

Since a logical unit 67 includes a memory area 73, the device server 71 has at least the function of controlling the memory area 73 (memory 11).

The task manager 72 controls the sequence of executing a plurality of commands, thereby providing a task management function. For example, the task manager 72 controls the sequence of executing the tasks, LU commands, or queries held in the queue area 74.

As described above, the device server 71 performs a process related to control of the memory 11. Such a process includes the conversion of logical addresses to physical addresses or vice versa. A logical address is allocated by the host device 2 to data the host device 2 is to write to the memory device 1. As described above, a physical address is used to determine a write area (page) or an erase area (block) of the memory 11. The device server 71 manages the state where the memory area 73 corresponding to the device server 71 stores data. The management of the storage state includes managing the relationship between a page (or a physical block) at a physical address and data at a logical address the page holds and the erased state of a page (or a physical block) at a physical address (or the state where nothing has been written or invalid data has been held in a page at a physical address). For the management, the device server 71 holds, for example, a logical address/physical address conversion table (hereinafter, sometimes just referred to as a conversion table).

As an example of conversion, for example, logical addresses can be allocated in blocks as shown in FIG. 8. A fixed logical address offset is allocated to each page in each block. FIG. 8 shows a case where the size of a write unit of the memory 11 is 16 kB and logical addresses are allocated in units of 512 bytes of data.

### 1.2 Operation

### 1.2.1 Background Process

The memory device 1 of the first embodiment performs a background process described later when the queue (command queue) 74 of all the logical units 67 becomes empty and the host device 2 gives permission.

### 1.2.2 Types of Background Process

First, a background process performed by the memory device 1 will be explained. The background processes performed by the memory device 1 of the first embodiment can be considered to be the following six processes (1) to (6). For example, the CPU 42 mainly performs a background process.

(1) Garbage Collection

Garbage collection is the process of reusing a block that includes a specific amount of invalid data or more in the memory 11. Specifically, reusing means that the invalid data held in the block is transferred to a new block and then the block is made capable of being used as an erase block.

(2) Trim

Trim is the process of erasing the memory 11 in write group units instead of erasing the memory 11 in erase group units. In trimming, the host device 2 can determine unnecessary data in the memory 11 and erase the determined data.

(3) Wipe

Wipe is the process of allocating logical blocks to the memory 11 to reformat the memory 11.

(4) Bad block Management

For example, if the memory 11 has been used repeatedly, a bad block will develop.

The existence of such a bad block is determined as a result of a failure in a flush operation (erasing or the like) or a failure in a write operation (a bad block is detected by ECC36).

If bad blocks have been determined, these bad blocks are stored in a bad block table in the memory 11. As described above, the process of processing bad blocks is called bad block management

(5) Wear Leveling

In the memory 11, if data has been rewritten and erased repeatedly, data sometimes cannot be written. Therefore, only a specific block has been written to and erased from in a concentrated manner, the block alone reaches the end of the service life.

The operation to avoid this phenomenon is wear leveling. There are several wear leveling methods. In a storage medium using a NAND flash memory, an address signal from the outside of the memory 11 is converted into an address differing from one memory 11 to another so as to average the number of times each block is written to and erased from. The address conversion information is also written in the memory 11.

(6) Read Disturbance Handling Process

Read disturbance is a bit error occurring as a result of reading data repeatedly. Since a voltage is applied to the control gates of the unselected memory cells in the selected block, the stored data is destroyed as a result of the repetition of a read operation, resulting in the occurrence of an error. To suppress the read disturbance, the device manager 63 (CPU 42) grasps, for example, the number of times each block is read from and rewrites data periodically. Such an operation is called a read disturbance handling process.

In the first embodiment, orders of priority are set for the background processes (1) to (6) as shown in FIG. 9. For example, the types of background processes and their priority orders are set in the register 46. The orders of priority, the number of background processes, and the types of background processes are only one example of the first embodiment and may be changed suitably according to the device manager 63.

In addition, for example, the device manager 63 sets, in the register 46, a background process required by the memory device 1 as background processing information.

### 1.2.3 Setting of Permission of a Background Process

For example, the host device 2 might not permit the memory device 1 to perform a background process because of power consumption when the command queue 74 of the memory device 1 becomes empty. If the memory device 1 has not obtained permission from the host device 2, it does not perform a background process when the command queue 74 becomes empty.

The host device 2 sets whether to permit the memory device 1 to perform a background process in flag “BACKGROUND_OPS_EN (also referred to as permission setting) (not shown)” in the register 46 (FIG. 1).

Specifically, if the host device 2 does not permit the memory device 1 to perform a background process, it sets “BACKGROUND_OPS_EN” to “0.” If the host device 2 permits the memory device 1 to perform a background process, it sets “BACKGROUND_OPS_EN” to “1.” The host device 2 can change the setting of “BACKGROUND_OPS_EN” as needed. The memory device 1 checks the flag and performs a background process if “BACKGROUND_OPS_EN” has been set to “1.”

### 1.2.4 Setting of an Order of Importance of a Background Process

For example, the device manager 63 sets flag “BACK_GROUND_OPS_STATUS attribute (not shown)” in the register 46 according to the type of a background process required by the memory device 1, the number of background processes, the number of unused memory blocks in the memory 11 and others.

Specifically, having determined that the order of importance of a background process is “Critical,” the device manager 63 sets “BACK_GROUND_OPS_STATUS attribute” to “03.” Having determined that the order of importance of a background process is “Performance Impact,” the device manager 63 sets “BACK_GROUND_OPS_STATUS attribute” to “02.” Having determined that the order of importance of a background process is “Required,” the device manager 63 sets “BACK_GROUND_OPS_STATUS attribute” to “01.” Having determined that the order of importance of a background process is “Not Required,” the device manager 63 sets “BACK_GROUND_OPS_STATUS attribute” to “00.” A concrete method of determining an order of importance will be described below. However, the method of determining an order of importance of a background process can be modified as needed.

If the order of importance of a background process is “Critical,” the memory device 1 does not respond to any command, except for specific commands (a mode select command and the like). Since the memory device 1 cannot operate any further, the host device 2 causes the memory device 1 to perform a background process as early as possible having detected data on the necessity for the memory device 1 to perform a background process as described later. Then, for example, the order of importance of the background process may be supplied to the host device 2. The host device 2 may monitor the register 46, thereby checking the state of the background process.

### 1.2.5 Setting of the Necessity of a Background Process

For example, the device manager 63 sets “UFS Status bit (not shown)” in “BACKGROUND_OPS_IN (not shown)” in the register 46 on the basis of the setting of “BACK_GROUND_OPS_STATUS attribute” in the register 46.

Specifically, if the setting of “BACK_GROUND_OPS_STATUS attribute” in the register 46 is greater than or equal to a specific order of importance, the device manager 63 determines that a background process has to be performed and sets “UFS Status bit” in the setting value “BACKGROUND_OPS_IN” in the register 46 to “1.” In addition, if the setting of “BACK_GROUND_OPS_STATUS attribute” in the register 46 is lower than the specific order of importance, the device manager 63 determines that a background process need not be performed and sets “UFS Status bit” in “BACKGROUND_OPS_IN” in the register 46 to “0.”

For example, having checked that “UFS Status bit” in “BACKGROUND_OPS_IN” in the register 46 has been set to “1, the host device 2 causes the memory device 1 to perform a background process immediately or as early as possible.

A concrete method of determining an order of necessity of a background process will be described below. However, the determining method can be modified as needed. Then, for example, the order of the necessity of the background process may be supplied to the host device 2. The host device 2 may monitor the register 46, thereby checking the state of the background process.

### 1.2.6 Basic Operation of Memory Device 1 of the First Embodiment

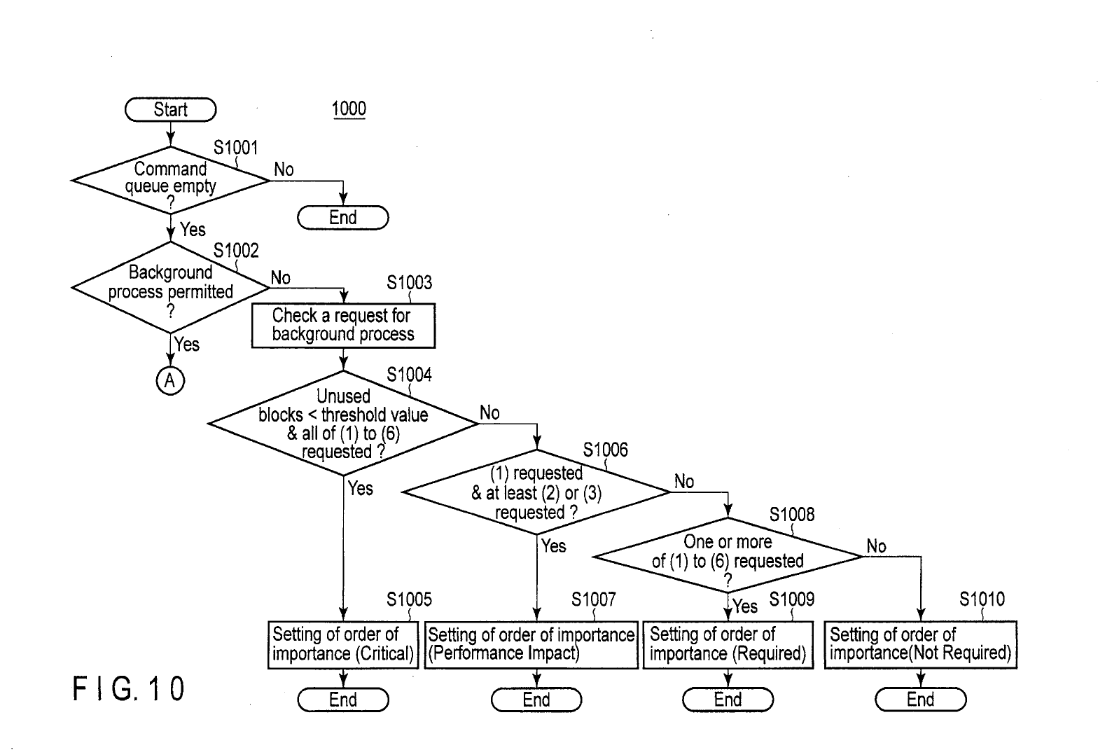

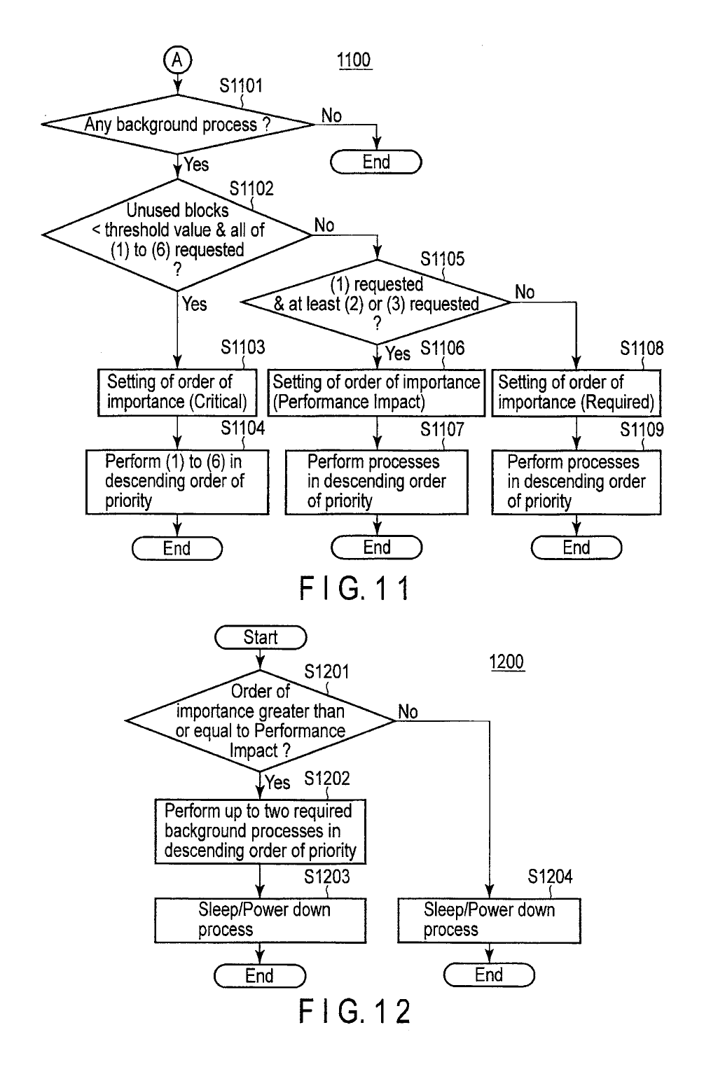

The basic operation of the memory device 1 according to the first embodiment will be explained with reference to FIGS. 10 and 11. FIG. 10 is a flowchart to explain the operation 1000 of setting an order of importance and an order of necessity of a background process in the memory device 1 according to the first embodiment. FIG. 11 is a flowchart to explain the operation 1100 of performing a background process in the memory device 1 according to the first embodiment.

### 1.2.6.1 Setting an Order of Importance and an Order of Necessity of a Background Process

[Step S1001]

As shown in FIG. 10, the device manager 63 determines whether the queue areas 74 in all the logical units 67 are empty. This may be realized by, for example, the device server 71 in each logical unit 67 informing the device manager 63 that the queue area 74 has become empty.

[Step S1002]

In step S1001, if the device manager 63 has determined that the command queues 74 in all the logical units 67 are empty, it checks the setting of “BACKGROUND_OPS_EN” in the register 46.

[Step S1003]

In step S1002, if the device manager 63 has checked that the setting of “BACKGROUND_OPS_EN” in the register 46 is “0,” indicating refusal of the background process, it checks a request for a background process from the memory device 1 and the number of unused blocks BLK.

[Step S1004]

The device manager 63 determines whether the conditions that the number of unused blocks in the memory 11 is less than the threshold value (the number of unused blocks<the threshold value) and all of the background processes (1) to (6) shown in FIG. 9 are necessary are satisfied. The threshold value can be changed as needed.

[Step S1005]

If the conditions in step S1004 are satisfied, the device manager 63 sets the order of importance of the background process to Critical and “BACK_GROUND_OPS_STATUS attribute” in the register 46 to “03.” If “BACK_GROUND_OPS_STATUS attribute” in the register 46 is greater than or equal to “02,” the device manager 63 determines that the background process has to be performed and sets “UFS Status bit” in “BACKGROUND_OPS_IN” in the register 46 to “1.”

For example, the device manager 63 informs the host device 2 of “BACK_GROUND_OPS_STATUS attribute” (the order of importance) in the register 46 or “UFS Status bit” (the order of necessity) in “BACKGROUND_OPS_IN.” In addition, the host device 2 may monitor the register 46, thereby checking the order of importance and order of necessity of the background process.

If the order of importance of the background process is “Critical,” the memory device 1 does not respond to any command, except for specific commands. The host device 2 causes the memory device 1 to perform a background process immediately or as soon as possible. As for the background processes, refer to operation 1100 described later.

[Step S1006]

If the conditions in step S1004 are not satisfied, the device manager 63 determines whether the conditions that item (1) in FIG. 9 is necessary and at least one of item (2) and item (3) in FIG. 9 is necessary are satisfied.

[Step S1007]

If the conditions in step S1006 are satisfied, the device manager 63 sets the order of importance of the background process to “Performance Impact” and “BACK_GROUND_OPS_STATUS attribute” in the register 46 to “02.” Then, the device manager 63 determines that it is necessary to perform a background process and sets “UFS Status bit” in “BACKGROUND_OPS_IN” in the register 46 to “1.”

[Step S1008]

If the conditions in step S1006 are not satisfied, the device manager 63 determines whether the condition that one or more of item (1) to item (6) in FIG. 9 are necessary is satisfied.

[Step S1009]

If the condition in step S1008 is satisfied, the device manager 63 sets the order of importance of a background process to “Required” and sets “BACK_GROUND_OPS_STATUS attribute” to “01.” Then, the device manager 63 determines that there is no need to perform a background process and sets “UFS Status bit” in “BACKGROUND_OPS_IN” in the register 46 to “0.”

[Step S1010]

If the condition in step S1008 is not satisfied, the device manager 63 sets the order of importance of a background process to “Not Required” and sets “BACK_GROUND_OPS_STATUS attribute” to “00.” Then, the device manager 63 determines that there is no need to perform a background process and sets “UFS Status bit” in “BACKGROUND_OPS_IN” in the register 46 to “0.”

### 1.2.6.2 Operation of Background Process

[Step S1101]

In step S1002, if the device manager 63 has checked that the setting of “BACKGROUND_OPS_EN” in the register 46 is “1,” indicating permission of a background process, it determines whether there is any background process required by the memory device 1.

[Step S1102]

In step S1101, if the device manager 63 has determined that there is a background process required by the memory device 1, it performs the same operation as in step S1004.

[Step S1103]

If the condition in step S1102 is satisfied, the device manager 63 performs the same operation as in step S1005.

[Step S1104]

The device manager 63 performs background processes (1) to (6) in FIG. 9 in descending order of priority. For example, after background processes (1) to (3) have been performed, the device manager 63 may set “BACK_GROUND_OPS_STATUS attribute” in the register 46 to “01,” indicating “Required.”

If BACK_GROUND_OPS_STATUS attribute” in the register 46 is “01,” the device manager 63 interrupts the background process and executes a new command when the host device 2 has supplied the new command to the memory device 1.

[Step S1105]

If the condition in step S1102 is not satisfied, the device manager 63 performs the same operation as in step 1006.

[Step 1106]

If the condition in step S1105 is satisfied, the device manager 63 performs the same operation as in step 1007.

[Step 1107]

Of the processes required, the device manager 63 performs background processes in descending order of priority.

[Step 1108]

If the condition in step S1105 is not satisfied, the device manager 63 performs the same operation as in step 1009.

[Step 1109]

Of the processes required, the device manager 63 performs background processes in descending order of priority.

### 1.3 Operational Advantages of the Memory Device of the First Embodiment

With the first embodiment, the memory device 1 comprises a nonvolatile memory 11 and a command storage module (queue area) 74 in which a command is stored. The memory device 1 further comprises a memory module (register) 46 in which the types of background processes and their order of priority are set, in which information of the background processes required is set, and in which a host device 2 sets permission or refusal of a background process. The memory device 1 further comprises a management module 63 which, having determined that a command has not been stored in the command storage module 74, determines whether the host device 2 has given permission to perform a background process, referring to the memory module 46, sets an order of importance of the background process in the memory module 46 on the basis of the number of unused blocks in the memory 11 and the orders of priority and the number of background processes required with reference to information and the order of priority set in the memory module 46 if permission of a background process has not been set, sets an order of importance of the background process in the memory module 46 on the basis of the number of unused blocks in the memory 11 and the types and number of background processes with reference to information of the background processes set in the memory module 46 having determined that the host device 2 has given permission to perform a background process, and performs background processes on the basis of information of the background processes set in the memory module 46 in order of priority. The management module 63 supplies information of the orders of importance set in the memory module 46 to the host device 2.

As described above, the memory device 1 can perform a background process efficiently.

For example, if the order of priority, order of importance, order of necessity, and the like of a background process have been determined ambiguously, the host device 2 cannot determine clearly to what extent the memory device 1 requires the execution of the background process. Therefore, the host device 2 cannot make the right decision about a case where the memory device 1 cannot accept a new command excluding a specific command unless the memory device 1 performs a background process. If unused blocks are not taken into account, the host device 2 cannot determine that a background process is unnecessary because, for example, there are sufficient unused blocks and that a background process is necessary because there are insufficient unused blocks. Therefore, the host device 2 cannot perform a background process properly.

However, the memory device 1 of the first embodiment determines an order of importance and an order of necessity of a background process on the basis of the number of unused blocks in the memory 11 and items (types and the number) of background processes. Therefore, the memory device 1 can clearly inform the host device 2 of the order of importance and order of necessity of a background process, including information as to whether the number of unused blocks is sufficient or insufficient. Therefore, the memory device 1 can perform a background process efficiently. In addition, since the memory device 1 can inform the host device 2 that the memory device 1 has to perform a background process immediately, a decrease in the performance of the memory device 1 can be suppressed.

Furthermore, since a background process is performed only when the command queue is empty, the performance of the memory device 1 is improved. Moreover, since the memory device 1 can determine whether a background process or the like is urgent, it can put a high priority on a command to the host device 2, suppressing the power consumption of the host device 2.

### Second Embodiment

Next, a second embodiment will be explained. A memory device according to the second embodiment has the same hardware configuration and functional blocks as those of the first embodiment. As for what has not been touched on in the explanation of the second embodiment, it should be noted that all the description of the first embodiment is applied to the second embodiment. The second embodiment is related to a case where a power-related command is input to the memory device 1 while the memory device 1 is performing a background process.

FIG. 12 is a flowchart to explain operation 1200 when a power-related command is input to the memory device 1 while the memory device 1 of the second embodiment is performing a background process.

### 2.1 Operation when Another Command is Input while a Background Process is being Performed

[Step S1201]

While the memory device 1 is performing a background process, the host device 2 sometimes issues a power-related command, such as a Sleep mode or Power Down, to the memory device 1.

In this case, the device manager 63 determines whether “BACK_GROUND_OPS_STATUS attribute” in the register 46 is “02” or “03,” indicating that the degree of importance is greater than or equal to “Performance Impact.”

In steps S1007 and S1006 explained in the first embodiment, if the conditions that item (1) in FIG. 9 is necessary and at least one of item (2) and item (3) in FIG. 9 is necessary are satisfied, the device manager 63 has set “BACK_GROUND_OPS_STATUS attribute” in the register 46 to “02.” However, in the second embodiment, if the condition that three or more background processes including item (1) in FIG. 9 are necessary is satisfied, the device manager 63 sets “BACK_GROUND_OPS_STATUS attribute” in the register 46 to “02.”

[Step S1202]

If “BACK_GROUND_OPS_STATUS attribute” in the register 46 is “02” or “03,” the device manager 63 performs up to two of the background processes required by the memory device 1 in descending order of priority. Thereafter, for example, the device manager 63 sets “BACK_GROUND_OPS_STATUS attribute” in the register 46 to “01,” indicating “Required.”

[Step S1203]

Having set “BACK_GROUND_OPS_STATUS attribute” in the register 46 to “01,” the device manager 63 executes a command requested by the host device 2. That is, the memory device 1 goes into the Sleep mode or executes Power Down.

[Step 1204]

If “BACK_GROUND_OPS_STATUS attribute” in the register 46 is “00” or “01,” the device manager 63 executes a command requested by the host device 2. That is, the memory device 1 goes into the Sleep mode or executes Power Down.

### 2.2 Operational Advantages of the Memory Device of the Second Embodiment

With the first embodiment, if the host device 2 inputs a command to the management module 63 while the module 63 is performing, for example, a background process, the management module 63 executes the background process if the order of importance set in the memory module 46 is greater than or equal to a specific value.

As described above, even if the host device 2 has issued a new command while the management module 63 is performing a background process, the memory device 1 can determine properly whether to stop or continue the background process by use of an order of importance.

While the memory device 1 is performing a background process, the host device 2 may request another command from the memory device 1. Even when the memory device 1 is performing an unnecessary background process, it may cause the host device 2 to wait for another command unless an order of importance or an order of necessity of a background process is determined clearly. This has an effect on the performance of the memory device 1.

However, in the memory device 1 of the second embodiment, an order of importance and an order of necessity of a background process are determined clearly. If the host device 2 has made a power-related request (e.g., the transition to the Sleep mode or Power Down) to the memory device 1 while the memory device 1 is performing a background process, it has been made clear how a background process is performed.

Therefore, if the memory device 1 needs to perform a background process immediately, a higher priority is put on a background process. If the memory device 1 need not perform a background process immediately, a higher priority is put on a request from the host device 2. This improves the performance of the memory device 1 and enables the power of the host device 2 to be used efficiently.

### 3. Modification and Others

While the setting of permission of a background process, an order of importance of a background process, an order of necessity of a background process, information of a background process, and others have been set in the register 46, the location where these pieces of information have been set is not necessarily limited to the register 46.

While in the second embodiment, if the condition that three or more background processes including item (1) in FIG. 9 are necessary is satisfied, the device manager 63 sets “BACK_GROUND_OPS_STATUS attribute” in the register 46 to “02.” However, even when the device manager 63 sets “BACK_GROUND_OPS_STATUS attribute” in the register 46 to “02” if another condition is satisfied, the second embodiment can be implemented.

While in the first and second embodiments, a UFS memory device has been used, any type of memory device may be used, provided that, for example, it is a memory system based on a client-server model.

In addition, while in the first and second embodiments, a UFS memory device has been used, another type of memory card, memory device, or internal memory may be used, provided that it is composed of a semiconductor memory device that operates in the same manner. In this case, too, the same operational advantages as those of the first and second embodiments are provided. In addition, the memory 11 is not limited to a NAND flash memory and may be another type of semiconductor memory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory device comprising:
a nonvolatile memory;
a command storage module in which a command is stored;
a memory module in which a type of a background process and an order of priority of the background process are set, in which information of first background processes is set, and in which permission or refusal of the background process is set by a host device; and
a management module which, having determined that no command has been stored in the command storage module, refers to the memory module and determines whether the host device has given permission for the background process to be performed and which, if the host device has not given permission for the background process to be performed, checks the number of unused blocks in the memory, orders of priority and the number of background processes from the information of the first background processes set in the memory module and sets the order of importance of the background process in the memory module based on the number of unused blocks in the memory and the orders of priority of the first background processes, and the number of the first background processes.

2. The memory device of claim 1, wherein the management module supplies information of the order of importance set in the memory module to the host device.

3. The memory device of claim 1, wherein the management module determines whether the number of unused blocks in the memory is smaller than a threshold value and all the types of background processes set in the memory module are required.

4. The memory device of claim 3, wherein the management module determines the order of importance of the background process to be a first order of importance and sets the first order in the memory module having determined that the number of unused blocks in the memory is smaller than the threshold value and all the types of background processes set in the memory module are required.

5. The memory device of claim 4, wherein the management module causes the host device to give permission for the background process to be performed when the first order of importance is set in the memory module.

6. The memory device of claim 3, wherein the management module determines whether a background process with the highest order of priority and the other background processes are required having determined that the number of unused blocks in the memory is larger than the threshold value and/or all the types of background processes set in the memory module are not required.

7. The memory device of claim 6, wherein the management module determines the order of importance of the background process to be a second order of importance and sets the second order in the memory module having determined that a background process with the highest order of priority and the other background processes are required.

8. The memory device of claim 6, wherein the management module determines whether any one of the background processes is required having determined that a background process with the highest order of priority is not required or none of the other background processes are required.

9. The memory device of claim 8, wherein the management module determines the order of importance of the background process to be a third order of importance and sets the third order in the memory module having determined that any one of the background processes is required.

10. The memory device of claim 8, wherein the management module determines the order of importance of the background process to be a fourth order of importance and sets the fourth order in the memory module having determined that any one of the background processes is not required.

11. The memory device of claim 1, wherein the management module, when referring to the memory module and determining that the host device has given permission for the background process to be performed, checks the number of unused blocks in the memory, the orders of priority and the number of the first background processes from the information of the first background processes set in the memory module,
sets an order of importance of the background process in the memory module based on the number of unused blocks in the memory, the orders of priority of the first background processes, and the number of the first background processes, and
performs, in order of priority, background processes based on the information of the first background processes set in the memory module.

12. The memory device of claim 11, wherein the management module determines whether the number of unused blocks in the memory is smaller than a threshold value and all the types of background processes set in the memory module are required.

13. The memory device of claim 12, wherein the management module determines the order of importance of the background process to be a first order of importance and sets the first order in the memory module having determined that the number of unused blocks in the memory is smaller than the threshold value and all the types of background processes set in the memory module are required.

14. The memory device of claim 12, wherein the management module determines whether either a background process with the highest order of priority or the other background processes are required having determined that the number of unused blocks in the memory is larger than the threshold value and/or all the types of background processes set in the memory module are not required.

15. The memory device of claim 14, wherein the management module determines the order of importance of the background process to be a second order of importance and sets the second order in the memory module having determined that either a background process with the highest order of priority or the other background processes are required.

16. The memory device of claim 14, wherein the management module determines the order of importance of the background process to be a third order of importance and sets the third order in the memory module having determined that a background process with the highest order of priority is not required and/or none of the other background processes are required.

17. The memory device of claim 11, wherein the management module, when the host device has input a command while the management module is performing the background process, performs the background process before executing the command if the order of importance set in the memory module is greater than or equal to a specific order of importance.

18. The memory device of claim 17, wherein the management module, when the host device has input a command while the management module is performing the background process, performs up to two of the first background processes.

19. The memory device of claim 17, wherein the command is a power-related request.

20. A memory device comprising:
a nonvolatile memory;
a memory module in which a type of a background process and an order of priority of the background process are set and in which information of the first background processes is set; and
a management module which sets an order of importance of the background process in the memory module based on the number of unused blocks in the memory, orders of priority of the first background processes, and the number of the first background processes.
